(19) United States
(12) Patent Application Publication
(10) Pub. No.: US 2016/0069432 A1
(43) Pub. Date: Mar. 10, 2016

(54) TENSIONING OR GUIDE RAIL HAVING A RIVETED SLIDING LINING BODY

(71) Applicant: IWIS MOTORSYSTEME GMBH & CO. KG, München (DE)

(72) Inventor: Franz WACH, Icking (DE)

(21) Appl. No.: 14/784,557

(22) PCT Filed: Feb. 13, 2014
(86) PCT No.: PCT/EP2014/000398

§ 371 Date: Oct. 14, 2015

(30) Foreign Application Priority Data
Apr. 18, 2013 (DE) 10 2013 006 679.4

(51) Int. Cl. F16H 7/08; F16H 7/18

(52) U.S. Cl. CPC F16H 7/08; F16H 7/18; F16H 2007/185; F16H 2007/0872

(57) ABSTRACT

A tensioning or guide rail for a flexible drive, in particular a chain drive of an internal combustion engine, comprises a support body, a sliding lining body attached to the support body and provided with a sliding surface for contacting a flexible drive means. In addition, the sliding lining body has a fastening opening extending from a rear face, which rests on the support body, to the sliding surface and having arranged therein a fastening bolt connected to the support body by a force-closed connection or an integral bond, and the fastening bolt comprises an enlarged formed head produced by means of a riveting process and used for securing the sliding lining body on the support body.

The present invention relates to a tensioning or guide rail for a flexible drive, in particular a chain drive of an internal combustion engine, comprising a support body, a sliding lining body attached to the support body and provided with a sliding surface for contacting a flexible drive means.

This kind of tensioning or guide rail is known e.g. from DE 10333077 A1. The rails are normally used for chain drives of an internal combustion engine and must therefore withstand high loads. The bipartite configuration of such a rail has the advantage that the support body can be produced from a material chosen under the aspect of stability, whereas the material for the sliding lining body is chosen under the aspect of its sliding characteristics. In the case of the known rail, a support surface of the support body has provided thereon locking devices and guide webs engaging complementary openings on the sliding lining body. The opposite end of the sliding lining body is provided with a hook end which rests on an undercut of the support body. This prevents the sliding lining body from being pulled off from the support body due to the forces generated by the chain running therealong. Such structural designs are disadvantageous insofar as they require substantial shaping both at the support body and at the sliding lining body, whereby higher manufacturing costs are automatically incurred.

It is therefore the object of the present invention to provide a tensioning or guide rail of the type mentioned at the beginning, which can be manufactured at a more reasonable price.

According to the present invention, this object is achieved in that the sliding lining body comprises a fastening opening extending from a rear face, which rests on the support body, to the sliding surface and having arranged therein a fastening bolt connected to the support body by a force-closed connection or an integral bond, and that the fastening bolt comprises an enlarged formed head produced by means of a riveting process and used for securing the sliding lining body on the support body. Hence, a rail having this kind of structural design necessitates the use of a formed head, which has been formed only after mounting of the sliding lining body. In this way, an intimate connection is established between the sliding lining body and the support body, which compensates the manufacturing tolerances and which, depending on the way in which the riveting process is carried out, establishes a very firm connection between these two elements. Indeed, the sliding lining body can here, at least when new, be applied to the support body with a certain amount of pretension. Due to the fact that the formed head is only produced by the riveting process, very simple shapes can be used for the fastening bolt. Accordingly, the shape of the associated fastening opening on the sliding lining body can be very simple. Manufacturing costs can be reduced to a very high extent in this way. The nature of the riveting process extremely depends on the material used for the support body. Materials suitable for use in this respect are metallic materials or plastics. Also the use of a plurality of riveted fastening bolts and of fastening openings associated therewith is possible.

In order to prevent the sliding lining body from being pulled off from the support body in transverse and longitudinal directions, the fastening opening preferably has a closed configuration on the inner circumference thereof. Especially when the fastening bolt is inserted into the fastening opening in a substantially closely fitting manner, it will also be possible to prevent any longitudinal or transverse displacement at this point.

According to an advantageous embodiment, the fastening bolt is not subsequently inserted in or connected to the support body, but is formed integrally with the support body. Preferably, this is done making use of the same material. If e.g. plastic material is used for producing the support body, the fastening bolt can very easily be formed onto the support body through the respective shape of an injection mold. Insofar, “connected by an integral bond” also comprises this integral formation of the fastening bolt and of the support body.

According to a further embodiment, the formed head is arranged in the fastening opening such that it is countersunk relative thereto. The degree of countersinking depends on the field of use of the tensioning or guide rail. If the chain sliding therealong is a bush-type or roller chain, the formed head may protrude to a certain extent beyond the sliding surface, provided that said protrusion does not come into contact with the chain to be tensioned and guided, respectively. Other chains, e.g. toothed chains, require, when used in their most common structural form, a formed head that does not protrude beyond the sliding surface.

This kind of fastening between the sliding lining body and the support body also provides the possibility of producing the sliding lining body by means of an extrusion process. In this respect, it will be advisable to use a strand extrusion process, sliding lining bodies having the desired length being then cut off from this strand. These sliding lining bodies will then only have to be provided with the at least one fastening opening, whereupon they can be connected to the support body. This is an extremely cost-efficient manufacturing mode because, with the exception of the fastening opening, the sliding lining body exhibits a uniform cross-sectional shape. In addition, the extrusion process is, essentially, less expensive than an injection molding process, which may, however, be used alternatively.

According to another embodiment, the support body comprises, in addition to the fastening bolt, at least one fixing element located in opposed relationship with an end face of the sliding lining body. This fixing element is used for additionally securing the sliding lining body, in particular in cases where only a single fastening bolt is used. Preferably, this fixing element is provided remote from the fastening bolt, so that a rotation of the sliding lining body about the axis of the fastening bolt can be prevented by means of very small forces.

According to an advantageous embodiment, the fixing element may be hook-shaped and it may grip over the sliding surface of the sliding lining body, at least partially. By means of this measure, lifting off of the sliding lining body, normally at a distance from the fastening bolt, is additionally prevented. Tensioning or guide rails are normally arcuate in shape. The arcuate shape can be configured such that the portion of the hook-shaped fixing element located on the sliding surface does not participate in guiding the flexible drive means. If the sliding lining body should have guide walls, the hook-shaped fixing element may engage therebetween, whereby an additional locking effect is given.

In addition, the present invention relates to a flexible drive, in particular a chain drive of an internal combustion engine, comprising a drive gear, at least one driven gear, a flexible drive means connecting the drive gear with the at least one driven gear, and a tensioning and/or guide rail according to one of the claims 1 to 7.

Especially in the case of timing chain drives in which the crankshaft sprocket drives the at least one camshaft sprocket, an extremely large number of tensioning and/or guide rails is used, and, consequently, measures taken for reducing the production costs are very effective.

Furthermore, the present invention relates to a method of manufacturing a tensioning or guide rail for a flexible drive, comprising the following steps:

providing a support body with a fastening bolt protruding from a support surface, said fastening bolt being connected to the support body by a force-closed connection or an integral bond,

providing a sliding lining body having a fastening opening, which extends from a rear face of the sliding lining body to a sliding surface,

attaching the sliding lining body with said fastening opening to the fastening bolt of the support body, and

forming the free end of the fastening bolt so as to create a rivet joint between the sliding lining body and the support body.

On the basis of these method steps, it will e.g. not be necessary to subsequently apply a rivet, since the element(s) required for riveting is/are already a constituent part of the support body to be joined to the sliding lining body. Mounting of these two elements is thus substantially simplified. In addition, the connection between the fastening bolt and the support body can already be checked and examined in advance, provided that a connection technique is here used. The integral structural design is, however, advantageous as well. Also a plurality of fastening openings and associated fastening bolts may be used simultaneously.

According to a preferred embodiment, the sliding lining body may be produced by means of an extrusion process and the fastening opening may be formed therein subsequently, in particular by means of punching. This allows sliding lining bodies to be produced continuously from a strand, whereby a reduction of costs can be accomplished. Also a subsequent incorporation of fastening openings, which normally have a simple geometry, can be accomplished in a cost-efficient manner.

According to a preferred embodiment, the fastening opening may define an undercut recessed relative to the sliding surface and having formed thereinto the free end of the fastening bolt by means of the forming step. The reshaped material of the fastening bolt will then cling closely to these areas of the fastening opening and guarantee reliable anchoring. The nature and the shape of the undercut will then also provide the fastening shape and a possible protrusion of the thus produced formed head. The incorporation of such undercuts is normally easily possible, e.g. by punching out a conical fastening opening or by hot forming a thermoplastic material.

According to an embodiment, the fastening bolt may, starting from the support surface of the support body, have a length which, prior to the forming step, is larger than the distance between the rear face and the sliding surface on the sliding lining body. Hence, a sufficient amount of material exists for the forming process, i.e. the diameter of the fastening bolt need not be excessively large.

In addition, the forming step may be carried out by means of wobble riveting or radial riveting or tempering. The type of riveting chosen normally depends on the material of the support body. If e.g. a plastic material, in particular a thermoplastic material, is used, it will be advisable to make use of tempering, i.e. the forming of a formed head by introduction of heat. In the case of metallic materials, other types of riveting should be preferred accordingly.

In the following, embodiments of the present invention will now be explained making reference to the drawings, in which:

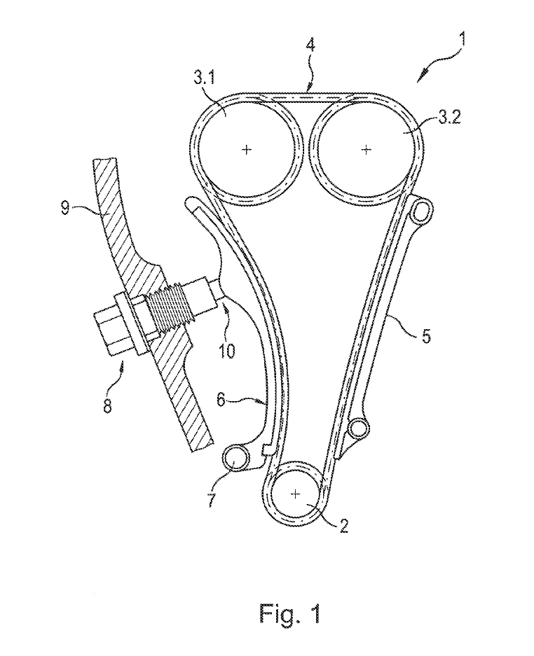

FIG. 1 shows a schematic front view of a timing chain drive,

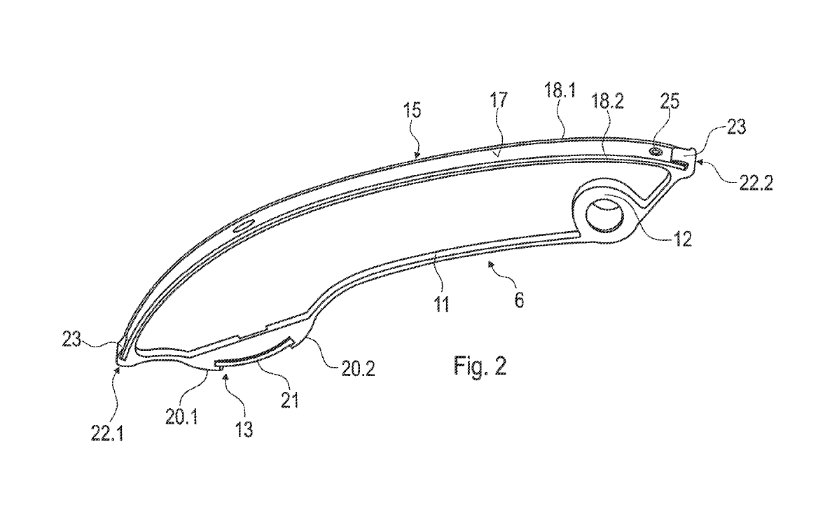

FIG. 2 shows a perspective front view of a tensioning rail,

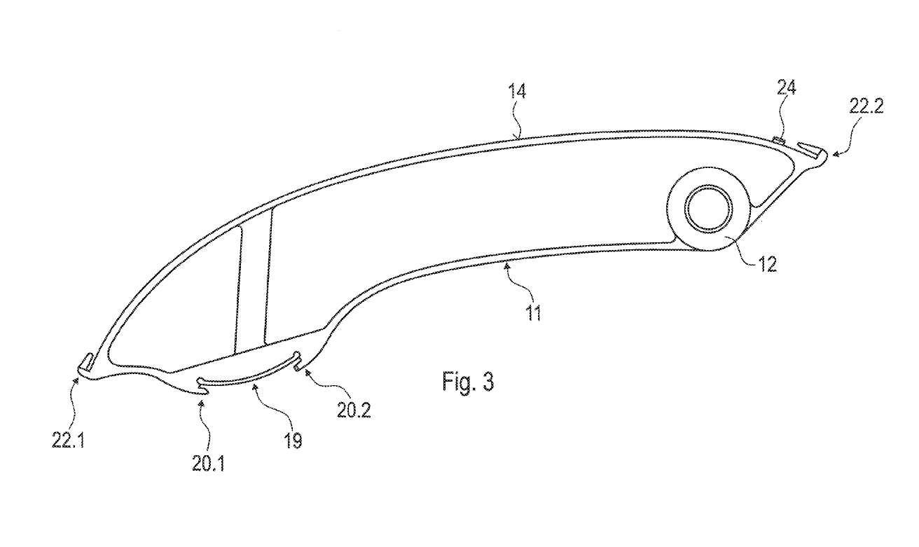

FIG. 3 shows a side view of the support body of the tensioning rail according to FIG. 2,

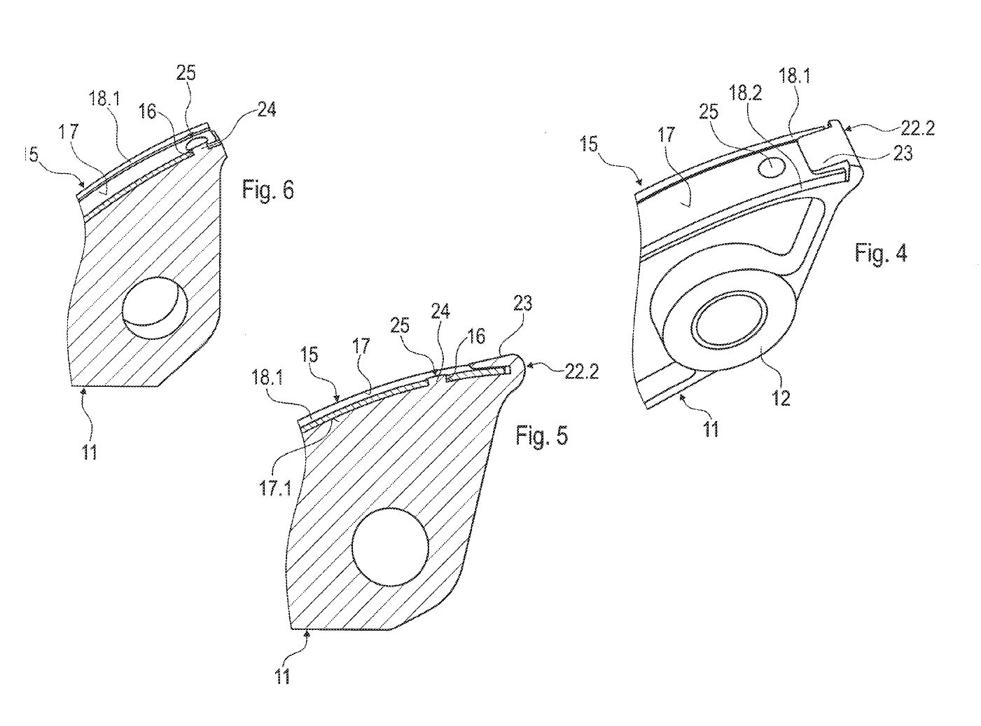

FIG. 4 shows an enlarged representation of the rear portion of the tensioning rail according to FIG. 2,

FIG. 5 shows the rear portion of the tensioning rail according to FIG. 4 in a full sectional view,

FIG. 6 shows a further embodiment of a rear portion of a tensioning rail in a perspective full sectional view,

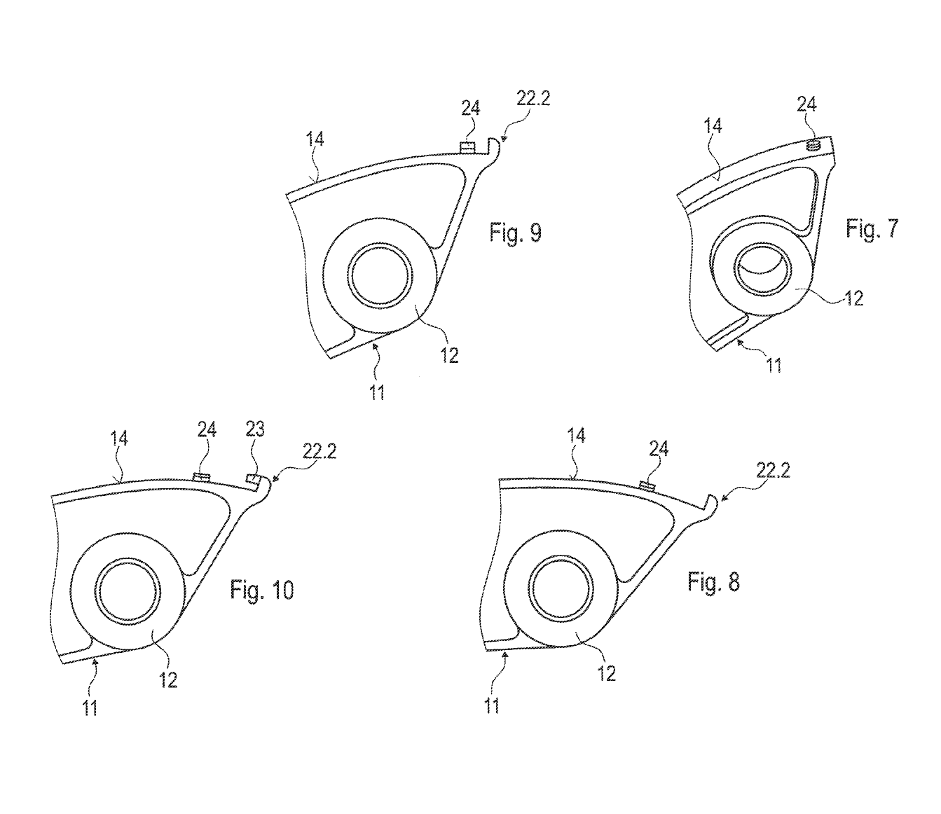

FIG. 7 shows the rear portion of the support body according to FIG. 6 in a perspective view,

FIG. 8 shows a further embodiment of a rear portion of a tensioning rail in a front view,

FIG. 9 shows a further embodiment of a rear portion of a tensioning rail in a front view, and

FIG. 10 shows a further embodiment of a rear portion of a tensioning rail in a front view.

FIG. 1 shows schematically a timing chain drive 1 comprising essentially a crankshaft sprocket 2, two upper camshaft sprockets 3.1 and 3.2, an endless timing chain 4 wrapped around the sprockets 3.1, 3.2, and a guide rail 5 as well as a tensioning rail 6. The tensioning rail 6 is pivotably supported at its pivot point 7 and, by means of a chain tensioner 8 arranged in part of the engine case 9, it is pressed against the timing chain 4 in that the tensioning piston 10 of the chain tensioner 8 applies pressure to the rear face of the tensioning rail 6.

The guide rail 5 is associated with the tight span of the timing chain drive 1, and the tensioning rail 6 is associated with the slack span. Such a timing chain drive 1 is a highly dynamic device, which must cope with high speeds on the one hand and resist the varying dynamic loads on the other. In so doing, the component parts reach their load limits.

In the following, a first embodiment of a tensioning rail will be explained in more detail making reference to FIGS. 2 to 5, said type of tensioning rail being adapted for use in the abovementioned timing chain drive 1. In the following, only tensioning rail embodiments will be discussed exemplarily. The fundamental structural design may, however, also be used for guide rails 5.

The tensioning rail 6 comprises a support body 11 made of a plastic material, said support body 11 defining at one end portion thereof a pivot sleeve 12 for realizing the pivot point and at the other end portion thereof an elevated press-on area 13. The support body 11 additionally comprises a curved support surface 14 having arranged thereon a sliding lining body 15 produced by means of an extrusion process. Also the sliding lining body 15 is produced from a plastic material. The sliding lining body 15 exhibits a uniform cross-section throughout its length, said uniform cross-section being only interrupted by a fastening opening 16 at one point thereof. The sliding lining body 15 has guide walls 18.1 and 18.2 on both sides of its sliding surface 17.

The fastening opening 16 is conical in shape, at least in the part adjoining the sliding surface 17, so that it provides an undercut.

The support body 11 has on its press-on area 13 an accommodation pocket 19 whose bottom is arcuate in shape and whose side walls are defined by hook elements 20.1, 20.2. This accommodation pocket 19 has inserted therein a press-on piece 21, which has the same cross-section as the sliding lining body 15 and which can be produced by the same extrusion process. Due to the also existing side walls on the press-on piece, the latter is reliably secured in position within the accommodation pocket 19 against lateral pushing out, whereas the hook elements 20.1 and 20.2 prevent dropping out from the accommodation pocket 19.

The front and the rear end of the support surface 14 are each provided with a hook-shaped fixing element 22.1 and 22.2. The actual hook portion 23 gripping over the sliding lining body 15 is reduced in width so that it can be inserted between the guide walls 18.1 and 18.2 of the sliding lining body 15 and can rest on the sliding surface 17. Hence, the distance between the support surface 14 and the lower surface of the hook portion 23 is smaller than the overall height of the sliding lining body 15. The part of the fixing element 22.1 and 22.2 extending perpendicular to the support surface 14 is enlarged in width in comparison with the hook portion 23 and is therefore able to provide a fixing means for the sliding lining body 15 across the whole width. A fixing means for the sliding lining body 15 is not absolutely necessary, as can be seen from FIG. 5. Also differences in thermal expansion can be compensated for in this way.

The fixing elements 22.1 and 22.2 are arranged in areas of the tensioning rail 6 which do not come into contact with the timing chain 14, so that the timing chain 4 will not come into contact with the fixing element 22.

The end face of the tensioning piston 10 of the chain tensioner 8 presses against the press-on piece 21 thus protecting the support body 11.

The support surface 14 has centrally arranged thereon a substantially cylindrical fastening bolt 24 at a small distance from the fixing element 22.2. The respective figures show said fastening bolt 24 in its already deformed condition. Accordingly, the fastening bolt 24 comprises a frustoconical formed head 25, which adapts itself in a closely fitting manner to the conical widening of the fastening opening 16. This formed head 25 does not project beyond the sliding surface 17 and is thus recessed relative thereto. Whereas the connection of the sliding lining body 15 by means of the fixing elements 22.1, 22.2 is a primarily form-fit connection, though a connection requiring that the sliding lining body 15 is bent in advance, the fastening bolt 24 represents, together with the fastening opening 16, a non-releasable connection due to the formed head 25, the only possibility of eliminating said non-releasable connection being therefore destruction.

In the following, the method of manufacturing such a tensioning rail 6 will be explained in more detail.

First, the support body 11 is produced by means of injection molding in an injection molding machine. In so doing, the fastening bolt 24 is given a cylindrical shape. In a separate method step, the sliding lining body 15 is formed by means of an extrusion process. The extrusion strand is then divided by means of a punching or cutting process so as to obtain the individual sliding lining bodies 15. Subsequently, the sliding lining body 15 has formed therein the fastening opening 16. This can be done e.g. by means of punching. Also the conical widening may be produced by means of punching or by a hot forming process. Also the press-on piece 21 is produced by an extrusion process, in that it is cut off from the extrusion strand. Subsequently, the press-on piece 21 is inserted into the accommodation pocket 19. To this end, the press-on piece is first inserted into one of the hook elements 20.1 or 20.2, whereupon it is bent to such an extent that it can also be brought into locking engagement with the opposite hook element 20.1 or 20.2. In a similar way, also the sliding lining body 15 is now arranged on the support surface 14 of the support body 11. Upon inserting one end of the sliding lining body 15 into the fixing element 22.2, care should be taken that the fastening opening 16 is in alignment with the fastening bolt 24, so that the latter can extend through said fastening opening 16. Subsequently, the opposite end of the sliding lining body 15 is lockingly engaged with the opposite fixing element 22.1, in that the sliding lining body 15 is bent. The fastening of the sliding lining body 15 may, however, also be executed in reverse order, in that insertion into the fixing element 22.1 is carried out first and the opposite end is fixed in position subsequently. Finally, the free, protruding area of the fastening bolt 24 is deformed by means of tempering (riveting process), so that the formed head 25 will assume its conical shape and cling closely to the conically extended section of the fastening opening 16. To this end, the fastening bolt 24 has, in its initial condition, a length that is larger than the distance between the rear face 17.1 of the sliding lining body and the sliding surface 17. Due to the use of a thermoplastic material for the support body 11, this is very easily possible.

If some other material is used for the support body 11, wobble riveting or radial riveting may, alternatively, also be used for shaping the formed head 25. In principle, all riveting processes should, however, be covered. In this context, it is particularly advantageous that the fastening bolt 24 and the support body 11 are formed uniformly of the same material.

Making reference to FIGS. 6 to 10, design variants will now be explained in more detail, in particular those of the pivotable end of the tensioning rail 6. As far as possible, the same reference numerals will be used for elements having the same structural design and producing the same effect. The above description is therefore additionally referred to and only the essential differences will be discussed in the following.

The embodiment according to FIGS. 6 and 7 is different insofar as no fixing element 22.2 is provided on the pivotable end of the support body 11, but fastening through the fastening bolt 24 and the fastening opening 16 is exclusively relied on. For this purpose, the fastening bolt 24 has been displaced to a position closer to the end. The same applies to the fastening opening 16.

The embodiment according to FIG. 8 does not require more than a fixing element 22.2, which does not comprise a hook portion 23 gripping over the sliding lining body 15. On the contrary, fastening through the fastening bolt 24 is exclusively relied on. The fixing element 22.2 primarily serves as a stop for the joining process and as a locking device. The embodiment according to FIG. 9 has the same structural design. The distance between the fixing element 22.2 and the fastening bolt 24 has, however, been reduced.

According to the embodiment of FIG. 10, a fixing element 22.2 having a shorter hook portion 23 is used.

Although the fastening bolt 24 is preferably formed integrally with the support body 11, it may also be formed separately and connected fixedly to the support body 11. What is mainly important is that the fastening bolt 24 is arranged on the support surface 14 already prior to the riveting process, so that the riveting process will not necessitate that a small fastening element is threaded through the fastening opening 26 and subsequently connected to the support body 11.

The present invention constitutes a cost-efficient possibility of producing tensioning and guide rails 5, 6.

1. A tensioning or guide rail for a flexible drive, in particular a chain drive of an internal combustion engine, comprising a support body, a sliding lining body attached to the support body and provided with a sliding surface for contacting a flexible drive means, wherein the sliding lining body comprises a fastening opening extending from a rear face, which rests on the support body, to the sliding surface and having arranged therein a fastening bolt connected to the support body by a force-closed connection or an integral bond, and the fastening bolt comprises an enlarged formed head produced by means of a riveting process and used for securing the sliding lining body on the support body, wherein the support body comprises, in addition to the fastening bolt, at least one fixing element located in opposed relationship with an end face of the sliding lining body, and that the fixing element is hook-shaped and grips, at least partially, over the sliding surface of the sliding lining body.

2. The tensioning or guide rail according to claim 1, wherein the fastening opening has a closed configuration on the inner circumference thereof.

3. The tensioning or guide rail according to claim 1, wherein the fastening bolt is formed integrally with the support body.

4. The tensioning or guide rail according to claim 1, wherein the formed head is arranged in the fastening opening such that it is countersunk relative thereto.

5. The tensioning or guide rail according to claim 1, wherein the sliding lining body is produced by means of an extrusion process.

6. (canceled)

7. (canceled)

8. A flexible drive, in particular a chain drive of an internal combustion engine, comprising a drive gear, at least one driven gear, a flexible drive means connecting the drive gear with the at least one driven gear, and a tensioning and/or guide rail according to claim 1.

9. A method of manufacturing a tensioning or guide rail for a flexible drive, comprising the following steps:
providing a support body with a fastening bolt protruding from the support surface, said fastening bolt being connected to the support body by a force-closed connection or an integral bond,
providing a sliding lining body having a fastening opening, which extends from a rear face of the sliding lining body to a sliding surface,
attaching the sliding lining body with said fastening opening to the fastening bolt,
forming the fastening bolt so as to create a rivet joint between the sliding lining body and the support body, wherein, starting from the support surface of the support body, the fastening bolt has, prior to the forming step, a length that is larger than the distance between the rear face and the sliding surface on the sliding lining body.

10. The method according to claim 9, wherein the sliding lining body is produced by means of an extrusion process and that the fastening opening is subsequently formed therein, in particular by means of punching.

11. The method according to claim 9, wherein the fastening opening defines an undercut recessed relative to the sliding surface and having formed thereinto the free end of the fastening bolt by means of the forming step.

12. (canceled)

13. The method according to claim 9, wherein the forming step is carried out by means of wobble riveting or radial riveting or tempering.
